(19) United States
(12) Patent Application Publication
(10) Pub. No.: US 2018/0116233 A1
(43) Pub. Date: May 3, 2018

(54) PROCESS FOR PRODUCING FROZEN BREAD WITH QUICK PREPARATION FOR CONSUMPTION

(71) Applicant: Dolciaria Orsobianco S.R.L., Borgo San Dalmazzo (IT)

(72) Inventors: Ivano Bonelli, Borgo San Dalmazzo (IT); Luca Bonelli, Borgo San Dalmazzo (IT)

(21) Appl. No.: 15/552,927

(22) PCT Filed: Feb. 18, 2016
(86) PCT No.: PCT/IT2016/000040

§ 371 Date: Aug. 23, 2017

(30) Foreign Application Priority Data
Feb. 23, 2015 (IT) TO2015A000121

(51) Int. Cl. A21D 15/02; A23L 3/375

(52) U.S. Cl. CPC A21D 15/02; A23L 3/375

(57) ABSTRACT

A process is described for producing bread, frozen/lowered in temperature, with quick recovery before its consumption, which comprises the steps of: cooking the bread, after levitation, to 90% with respect to its complete cooking; immediately lowering the temperature of the cooked bread through the use of liquid nitrogen, down to a lowering temperature at least equal to −60° C.; packaging and freezing the bread, through a first sub-step of obtaining a temperature from −10° C. to −11° C. in the bread core, and a second sub-step of keeping the bread at a freezing temperature of −18° C. for at least 12 hours; and storing and transporting the packaged bread, always at a temperature of at least −18° C.

### BACKGROUND OF THE INVENTION

### 1) Field of the Invention

The present invention refers to a process for producing bread, frozen/lowered in temperature, with quick recovery, before its consumption.

### 2) Background Art

In order to allow a wider and more prolonged consumption, the most common products from oven (bread, pasta, confectionery), as well as foodstuff products more in general, have been subjected for years to freezing, to be then heated and consumed afterwards in time with respect to their production.

Freezing, down to a temperature of approximately −18° C., of products from oven is a process which, upon their heating (completion of cooking) before their final consumption, implies very long times (on the order of 30 minutes) to obtain an edible product. Such long times are incompatible with uses of such products which provide for their immediate consumption by their users: think about a cake which must be consumed at breakfast, for which a user must wait for this period before its consumption, if the stocks of such cake run out in a short time.

In order to solve this type of problem, processes have been used (for example like the one disclosed in U.S. Pat. No. 4,986,992) in which a partially cooked (at about 80%) confectionery product is subjected to immediate freezing through the use of liquid nitrogen taking it down to an initial temperature of about −4° C. and then at the freezing temperature of −18° C., in a time equal to about 10-11 minutes. To allow such working, these confectionery products however provide for the use of additives, which is not optimum for the quality of the final product.

The Applicant of the present invention has already solved these problems by providing, in International Application WO-A-2014/061042, a process for producing confectionery products from oven without additives, frozen/lowered in temperature, with quick recovery before their consumption, which is simple to make, and which allows obtaining confectionery products which keep their internal structure free from additives and which can be recovered in very short times, obtaining again a final product with the same organoleptic features of the one which originally went out of its production oven.

### SUMMARY OF THE INVENTION

Object of the present invention is integrating the above mentioned process, applying it only to the production of bread, which process, though with the various facets implicit in the production of several types of bread, allows obtaining in a standardized way a bread as if newly cooked, after a quick recovery after its freezing and its transport to its place of use.

The above and other objects and advantages of the invention, as will result from the following description, are obtained with a process as claimed in claim 1. Preferred embodiments and non-trivial variations of the present invention are the subject matter of the dependent claims.

It is intended that all enclosed claims are an integral part of the present description.

### DETAILED DESCRIPTION OF PREFERRED EMBODIMENTS

The present invention will be better described by some preferred. embodiments thereof, provided as a non-limiting example, in fact, it will be immediately obvious that numerous variations and modifications (for example related to steps, quantities and compositions with equivalent functionalities) could be made to what is described, without departing from the scope of the invention as appears from the enclosed claims.

According to the invention, a process is provided for producing bread, frozen/lowered in temperature, with quick recovery before its consumption, comprising the steps of:
cooking the bread, after levitation, to 90% with respect to its complete cooking;
immediately lowering the temperature of the cooked bread through the use of liquid nitrogen, down to a lowering temperature at least equal to −60° C.;
packaging and freezing the bread, through a first sub-step of obtaining a temperature from −10° C. to −11° C. in the bread core, and a second sub-step of keeping the bread at a freezing temperature of −18° C. for at least 12 hours; and
storing and transporting the packaged bread, always at a temperature of at least −18° C.

The step of cooking can occur in a oven ad a temperature from 160° C. to 260° C. for a cooking time from 20 to 50 minutes according to the type of bread.

Moreover, the step of lowering the temperature down to −60° C. from the output of the step of cooking is preferably performed for a time equal to about 9 minutes.

The inventive process further comprises the step of taking back to ambient temperature the bread frozen/lowered in temperature through a stay at ambient temperature for a period of about 1 hour.

Finally, the inventive process comprises the final step of restoring the bread to take it back to the temperature at which it can be consumed, in a time preferably equal to about 3 minutes.

With the above described process, it is possible to make bread subjected to less stresses during its preparation and cooking, taking it back, in about 3 minutes of restoring after its freezing/temperature lowering, to its edible status like the newly cooked one, with a strong saving of times and costs for its end user.

The obtained bread is free from preservatives and is composed of selected raw materials, which guarantee its final freshness before its consumption.

The products made with the inventive process can be stored in a range of temperatures from −5° C. to −20° C. and are restored at about 200° C. for a period from 3 to 7 minutes.

### EXAMPLES

The present invention will be further described by using some application examples, provided as a non-limiting example, in order to allow a skilled person in the art to understand the evolution of the inventive process and of the product derived therefrom.

Two tests have been performed, a cooking test and a temperature lowering test for cooked bread of the baguette type. The test results are included in the following Tables.

As can be seen from this first Table, related to the results of the temperature-lowering tests of cooked baguette bread with respect to times and temperatures, the satisfactory results are those pointed out in the light-coloured boxes.

As can be seen from this second Table, related to the results of the cooking tests of baguette bread with respect to times and temperatures, the satisfactory results are those pointed out in the light-coloured boxes.

In order to complete the test, Test Cards are included below, which contain, in addition to test times and temperatures, the results of an evaluation test performed on a panel of 5 users, which have tasted the cooked baguette bread restored at the end of the process, and have assigned a rating equal to the maximum of scores for 100% of the panel users.

What is claimed is:

1-2. (canceled)

3. A process for producing bread, frozen with quick recovery before its consumption, the process comprising the steps of:
a) after leavening the bread, cooking the bread to 90% of cooked, the bread comprising a core and a crust;
b) after step (a) lowering an internal temperature of the cooked bread through the use of liquid nitrogen, down to a lowering temperature at least equal to −60° C. both in the crust, and in the core, wherein the step of lowering the internal temperature to −60° C. takes about 9 minutes;
c) packaging and freezing the bread, through a first sub-step of obtaining a first low temperature from about −10° C. to −11° C. in the bread core, and a second sub-step of keeping the bread at a second low temperature of −18° C. for at least 12 hours; and
d) after step c), storing and transporting the packaged bread at a temperature of at least −18° C.

4. The process of claim 3, wherein the step of cooking occurs in an oven at a temperature from 160° C. to 260° C., for a cooking time from 20 to 50 minutes.

5. The process of claim 3, further comprising step e) after step d), increasing the internal temperature of the bread to ambient room temperature by placing the bread in an ambient room temperature environment for about 1 hour.

6. The process of claim 5, further comprising step f) wherein after step e) increasing the internal temperature of the bread to a consuming temperature, wherein the step e) takes about 3 minutes.

7. A process for producing bread, frozen with quick recovery before its consumption, the process comprising the steps of:
a) cooking the bread;
b) after step (a) lowering an internal temperature of the cooked bread through the use of liquid nitrogen, down to a lowering temperature at least equal to −60° C.; and
c) packaging and freezing the bread, through a first sub-step of obtaining a first low temperature, and a second sub-step of keeping the bread at a second low temperature for at least 12 hours, wherein the second low temperature is lower than the first low temperature.

8. The process of claim 7 wherein step (b) takes about 9 minutes.

9. The process of claim 7, wherein step a) comprises cooking the bread to 90% cooked.

10. The process of claim 7, wherein step a) is performed after leavening.

11. The process of claim 7, wherein the first lower temperature of step c) is −10° C. to 11° C. in the bread core.

12. The process of claim 7, wherein the second lower temperature of step c) is −18° C.

13. The process of claim 7, wherein the step of cooking occurs in an oven at a temperature from 160° C. to 260° C. for a cooking time from 20 to 50 minutes.

14. The process of claim 7, further comprising step d) wherein after step (c), storing and transporting the packaged bread, always at a temperature of at least −18° C.

15. The process of claim 7, further comprising step e) wherein after step c), increasing in internal temperature of the bread to ambient room temperature by placing the bread in an ambient room temperature environment for about 1 hour.

16. The process of claim 15, further comprising step f) wherein after step e) increasing the internal temperature of the bread to a consuming temperature, wherein the step e) takes about 3 minutes.
